(19) United States
(12) Patent Application Publication
(10) Pub. No.: US 2007/0044616 A1
(43) Pub. Date: Mar. 1, 2007

(54) Device for three-sided cropping of products

(75) Inventors: Wolfgang Matthes, Kuhren-Burkhartshain (DE); Andreas Steinert, Beucha (DE); Falk Wagner, Beucha (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/510,985

(22) Filed: Aug. 28, 2006

Related U.S. Application Data
(60) Provisional application No. 60/713,485, filed on Sep. 1, 2005.

(30) Foreign Application Priority Data
Aug. 29, 2005 (DE) 10 2005 040 799.4

(51) Int. Cl. B26D 5/08

(52) U.S. Cl. 83/613

(57) ABSTRACT

A device for the three-sided cropping of products, includes a lifting configuration constructed for operating in a stroke movement determining a machine cycle of the device. At least knives for head cropping, foot cropping and front edge cropping of the products are to be mounted on the lifting configuration. A pressing device presses the products before cropping. A device terminates the pressing of the pressing device, in such a way that the pressing duration of the device can be varied.

### CROSS REFERENCE TO RELATED APPLICATIONS

This application claims the priority, under 35 U.S.C. § 119(e), of Provisional Patent Application No. 60/713,485 filed Sep. 1, 2005. This application also claims the priority, under 35 U.S.C. § 119, of German Patent Application DE 10 2005 040 799.4, filed Aug. 29, 2005; the prior applications are herewith incorporated by reference in their entirety.

### BACKGROUND OF THE INVENTION

### Field of the Invention

The invention relates to a device for the three-sided cropping of products, in particular brochures. The device includes a lifting configuration constructed to be operable in a stroke movement. The stroke movement determines a machine cycle of the device. At least knives for head cropping, foot cropping and front edge cropping of the products can be mounted on the lifting configuration. The device has a pressing device for pressing the products before cropping.

In the production of brochures, gathered and stitched products are cut in a device for three-sided cropping, for example a trimmer, on collective stitching machines. That takes place in cutting stations for a front cut and a head crop or foot crop through the use of an upper knife moved against a stationary lower knife. The cropping of the brochure in that case is a particularly important step, since the signatures are thereby opened laterally and the external appearance of the brochure is decisively influenced. For that purpose, it is important that the brochures be cut exactly in position. Consequently, before the cut, the product is transported and aligned laterally against front edge stops, in order to exactly set the sectional width for the head crop or foot crop. Before the start of cutting, the product is pressed against the lower knife by spring-loaded hold-down devices (press bars), in order to obtain a clean cutting surface. The press bars are fastened to an upper knife bridge and are disposed with respect to the cutting edge of the upper knife in such a way that they press the product before the penetration of the cutting edge. A trimmer of that type is known, for example, from European Patent Application EP 1 152 310 A1, corresponding to U.S. Patent Application Publication No. US 2001/0037708 A1. In the trimmer disclosed therein, due to the structure shown therein, the product remains pressed until the upper knife bridge is in an upward movement again after the cut. The point in time at which the product is released again by the spring-loaded press bars is dependent on the distance covered in the upward movement and on the product thickness. It is only after the release of the product that the latter can be conveyed to the next cutting station through the use of the transport configuration. The prior art therefore has a disadvantage that, in cutting devices of that type, the speed of the brochure in the cutting device is limited, since the rebound of the brochure at the front edge stop otherwise prevents a neat alignment and consequently a clean cut of the product.

### SUMMARY OF THE INVENTION

It is accordingly an object of the invention to provide a device for the three-sided cropping of products, which overcomes the hereinafore-mentioned disadvantages of the heretofore-known devices of this general type and which allows higher productivity.

With the foregoing and other objects in view there is provided, in accordance with the invention, a device for the three-sided cropping of products. The device comprises a lifting configuration being operable in a stroke movement determining a machine cycle of the device. Knives are to be mounted on the lifting configuration for at least head cropping, foot cropping and front edge cropping of the products. A pressing device presses the products before cropping. A device for terminating pressing of the pressing device varies a pressing duration within a duration of the machine cycle.

Therefore, due to the invention, it is possible to optimize the movement sequences in the trimmer in such a way that the product is released for transport as early as directly after the complete cut. This can be achieved, in particular, in such a way that the device for terminating the pressing of the pressing device fixes the press bar at this point in time in its position with respect to the upper knife bridge, and this fixing is canceled again only at the upper reversal point or in the downward movement of the upper knife bridge. As a result, the overall time available for the three-sided cropping of the product can be utilized more effectively. Moreover, it is possible, for example, to adapt the pressing duration to different product properties, such as its weight or dimensions. Above all, however, the pressing duration becomes independent of the product thickness.

In accordance with another feature of the invention, there is provided a transport configuration which brings the product into a first cutting position and from a first cutting position into a second cutting position within a transport duration. As already mentioned, this transport duration has a minimum which should not be undershot, since the braking of the product in the cutting position is otherwise made more difficult by the correspondingly increased transport speed. Accordingly, the control of the pressing device is advantageously provided in such a way that this control determines the point in time of the termination of the pressing of the pressing device in such a way that the transport duration of the product is substantially not increased in the event of a shortening of the cycle duration of the stroke movement of the lifting configuration. In this case, displacing the point in time of the termination of the pressing of the product within the machine cycle in the case of its shortened cycle duration ensures, even when the productivity of the cutting device is increased, that the transport of the product takes place with equal quality. It is thereby possible, with the transport duration remaining the same, to raise the machine cycle, for example, from 10,000 cycles per hour to 14,000 or 16,000 cycles per hour.

In accordance with a further feature of the invention, the pressing device is fastened to the lifting configuration, and the device for terminating the pressing includes a device for the temporary switching off of the pressing device.

In accordance with a concomitant feature of the invention, a plurality of knives, in particular the knives for front edge cropping, head cropping, foot cropping, middle cutting or trio cutting of the device, are associated with a correspondingly controllable pressing device.

Other features which are considered as characteristic for the invention are set forth in the appended claims.

Although the invention is illustrated and described herein as embodied in a device for the three-sided cropping of products, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of a cutting device for the edge cropping of products, according to the invention;

FIG. 2 is an enlarged, perspective view showing details of a transport system; and

FIG. 3 is a further enlarged, perspective view showing details of a pressing device.

### DESCRIPTION OF THE PREFERRED EMBODIMENTS

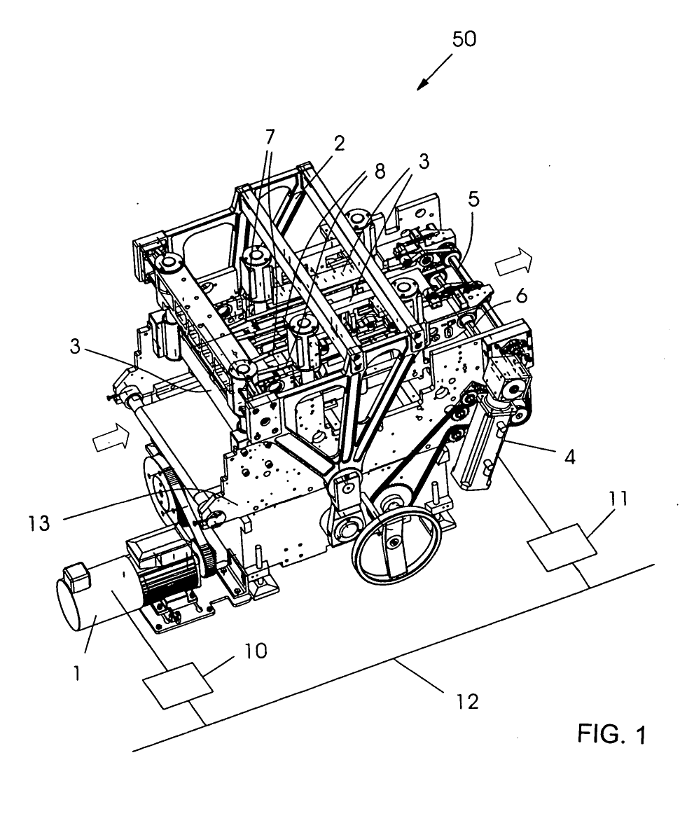

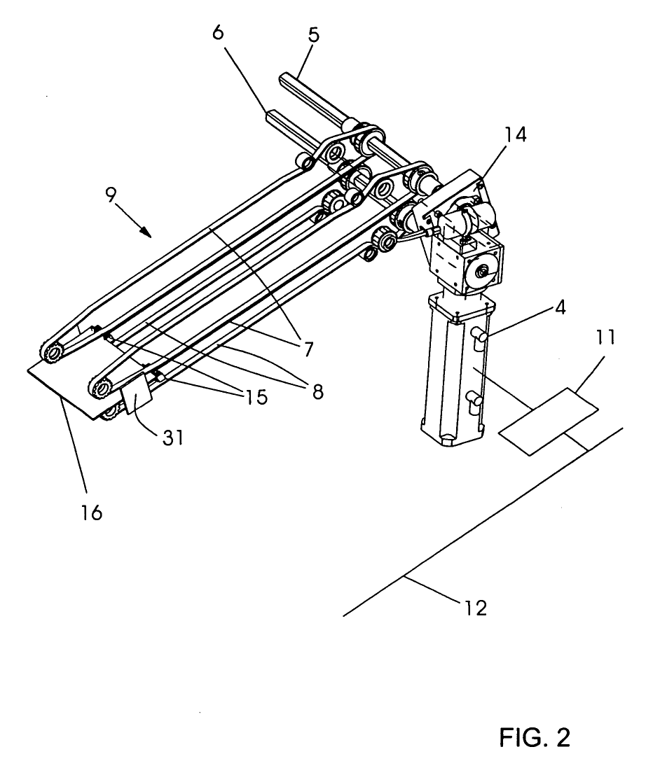

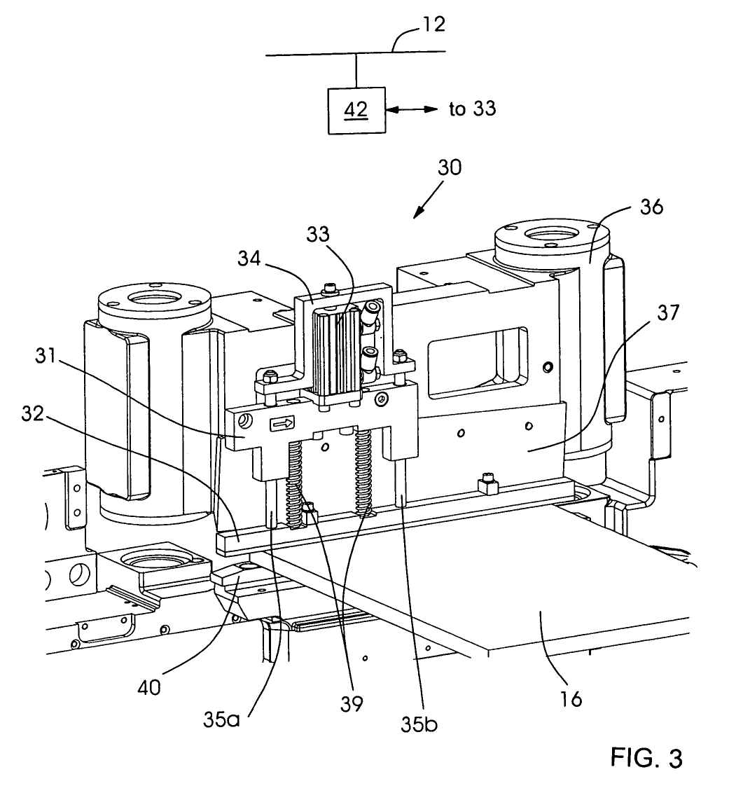

Referring now to the figures of the drawings in detail and first, particularly, to FIG. 1 thereof, there is seen a representative example of a cutting device 50 for the three-sided cropping of products. A first drive motor 1 executes movement of a knife lifting configuration 2 to which knives 3 are fastened. A product running direction is identified by arrows. A second drive motor 4 drives belts 7, 8 of a transport configuration 9, shown in greater detail in FIG. 2, through first and second drive shafts 5, 6. Control units 10, 11 which are provided for the two drive motors 1, 4 can communicate with one another through the use of a connection 12 for the exchange of data and/or control signals. Furthermore, the connection 12 may also lead to a machine control unit and to a control of an alignment configuration 42 shown in FIG. 3.

FIG. 2 separately illustrates the transport configuration 9. The drive motor 4 drives the drive shafts 5 and 6 and the belts 7, 8 of the transport configuration through the use of a mechanical gearing 14. Furthermore, the control unit 11 and the connection 12 for the exchange of data and/or control signals can be seen. The products, coming from a further non-illustrated transport system, out of the delivery of a stitching machine, are braked at front edge stops 15. It is possible to guide a product 16 smoothly up to the front edge stops 15 even at high speeds, by electronic control through the use of the control unit 11. For this purpose, for example, electronic cam disks may be provided for a servodrive of the stepping belts. Typically, the front edge stops 15 are provided only in a first cutting position for a front edge crop. Transport of the product 16 to a second cutting position by the transport configuration 9 takes place without any further alignment in this embodiment.

FIG. 3 illustrates a pressing device 30 according to the invention. In order to crop the product 16 in a cutting station, an upper knife bridge 36 together with an upper knife 37 moves intermittently against a stationary lower knife 40. A holder 31 is fastened to the upper knife bridge 36. A press bar 32 is mounted in the holder 31 through the use of guide bolts 35a, 35b which are firmly connected at one end to the press bar 32. The guide bolts 35a, 35b are connected to one another at the other end through the use of a bridge 34 and to a piston rod of a pneumatic cylinder 33 which is fastened to the holder 31. Compression springs 39 are mounted between the press bar 32 and the holder 31 and, in an initial state, provide a fixed spacing between the holder 31 and the press bar 32.

During the cutting movement for the product 16, the upper knife bridge 36 moves downward together with the upper knife 37. At the same time, the press bar 32 also moves downward, comes to sit on the product 16 and presses the latter together. During the further downward movement, the press bar 32 moves in relation to the holder 31 and in this case compresses the compression springs 39. The pneumatic cylinder is drawn into an extension position due to the press bar 32 being connected to the piston rod of the pneumatic cylinder 33 through the use of the guide bolts 35a, 35b and the bridge 34. At a lower reversal point or in the upward movement of the upper knife bridge 36, the pneumatic cylinder 33 is switched at a controllable point in time to an “extension” function and counteracts the force of the compression springs 39, due to its force which must be higher than the force of the compression springs 39. The press bar 32 is thereby held in its current position. During the further upward movement of the upper knife bridge 36, the pressing of the product 16 is thereby canceled immediately, not just when the compression springs 39 expand. Due to this time saving, the product 16 can be transported away earlier. At the upper reversal point of the upper knife bridge 36, the pneumatic cylinder 33 is switched to a “retraction” function and moves the press bar 32 into its initial position again. The control of the pneumatic cylinder 33 in this case takes place through the use of the alignment configuration or pressing device control 42 which is connected to other control units 10, 11 and the machine control provided through the connection 12 for the exchange of data and/or control signals. Lifting magnets, moving-coil actuators or motor-operated linear drives are possible as a further variant for the introduction of the countermovement to the compression springs.

During the continuous operation of the device 50 according to the invention, a front edge crop of a product 16 is carried out in a first cutting position and simultaneously a head crop or foot crop of a second product 16 is carried out in a second cutting position. Within a cycle of a stroke movement of the knife lifting configuration 2, the remaining components of the device 50 according to the invention, that is to say including the second product 16, must be transported from the device 50 out of the second cutting position, the first product 16 must be transported out of the first cutting position into the second cutting position and a new product 16 must be brought into the first cutting position. For this purpose, the transport configuration 9 must bring the product as far as the front edge stops 15 and, where appropriate, ensure the lateral alignment of the product before cropping. If, then, the machine cycle of the device 50 is increased, this does not mean that all of the other movements of the device are increased to the same extent. On the contrary, the transport duration of the product 16 within the device 50 should not undershoot a minimum transport duration, since the careful and reliable transport of the product 16 cannot otherwise be ensured. The duration of the pressing of the product can then be adapted, by virtue of the pressing device according to the invention, so that the cutting device 50 can nevertheless be operated at higher production speeds and consequently with a shorter cycle, in particular by the pressing device being fixed to the upper knife bridge, in such a way that the same amount of time remains for the transport of the product 16 within the cutting device 50.

The device has been described above particularly in connection with the three-sided cropping of brochures which are produced in a collective stitching machine. However, it is also readily conceivable to use the device for the three-sided cropping of other products. Moreover, it is conceivable to provide a corresponding device which carries out only one or two crops on a product or, correspondingly, more than three, for example in what is known as a trio cut.

We claim:

1. A device for the three-sided cropping of products, the device comprising:
a lifting configuration being operable in a stroke movement determining a machine cycle of the device;
knives to be mounted on said lifting configuration for at least head cropping, foot cropping and front edge cropping of the products;
a pressing device for pressing the products before cropping; and
a device for terminating pressing of said pressing device to vary a pressing duration within a duration of said machine cycle.

2. The device according to claim 1, which further comprises a transport configuration bringing the product into a first cutting position and from said first cutting position into a second cutting position within a transport duration.

3. The device according to claim 2, which further comprises a press control determining said pressing duration of said pressing device for ensuring that a transport duration of the products is substantially not increased in the event of a shortening of a cycle duration of said stroke movement of said lifting configuration.

4. The device according to claim 1, wherein said pressing device is fastened to said lifting configuration, and said pressing device includes a device for temporarily switching off of said pressing device to terminate the pressing.

5. The device according to claim 4, which further comprises a press bar for pressing the product on said lifting configuration, said press bar being fixed by said device for temporarily switching off said pressing device.

6. The device according to claim 1, wherein said controllable pressing device is associated with said knives.

7. The device according to claim 6, wherein said knives include knives for front edge cropping, head cropping, foot cropping, middle cropping or trio cutting.
